(19) United States
(12) Patent Application Publication
(10) Pub. No.: US 2017/0113952 A1
(43) Pub. Date: Apr. 27, 2017

(54) Recycled Water and Solids Management System

(71) Applicant: Truck Wash Technologies, Inc.

(72) Inventors: Robert John Stephenson, Vancouver (CA); Jyrki Koro, Sault Sainte Marie (CA)

(73) Assignees: Truck Wash Technologies, Inc.; Truck Wash Technologies, Inc.

(21) Appl. No.: 15/332,334

(22) Filed: Oct. 24, 2016

Related U.S. Application Data
(60) Provisional application No. 62/245,666, filed on Oct. 23, 2015.

(51) Int. Cl. C02F 1/52; B01D 21/01; C02F 1/78; C02F 1/72; C02F 1/76; B01D 21/00; C02F 1/38

(52) U.S. Cl. CPC C02F 1/5281; B01D 21/00; B01D 21/0087; B01D 21/01; C02F 1/5245; C02F 1/38; C02F 1/722; C02F 1/727; C02F 1/76; C02F 1/78; C02F 2103/44

(57) ABSTRACT

A method and device for treating spent wash water produced in operations such as heavy truck washing that includes hydraulic classification to remove fine sand and smaller particles from water such that up flow velocity of water plus solids in the classifier cause particulate solids to be retained in the classifier which promotes their agglomeration into larger particle sizes for easier subsequent removal for dewatering and disposal.

The present application is a continuation and a non-provisional application based on U.S. Ser. No. 62/245,666 filed Oct. 23, 2015. The contents of U.S. Ser. No. 62/245, 666 are incorporated by reference herein.

### BACKGROUND

The present disclosure is directed to method and devices pertaining to the production of treated water suitable for reuse in truck washing facilities and the like.

Trucks and various other pieces of large equipment periodically require washing as part of routine maintenance and upkeep. This process generates large quantities of spent wash water. The spent wash water contains significant concentrations of solid material removed from the equipment as part of the washing process in additional to any detergents or cleaning material employed in the washing process. The spent wash water that is generated represents significant resource cost and its disposal can be a significant environmental burden.

Spent wash water can contain organic material such as petroleum hydrocarbons that adhered to the vehicle and were removed during the washing process. Because the spent wash water can contain organic material such as petroleum hydrocarbons, great care must be taken to prevent environmental contamination. Typically, the spent wash water should not be introduced into sewage systems or directly into the ground without pretreatment to address potentially hazardous chemical contamination. In many situations, the waste wash water is either directly introduced to large settling pits or processed such that a smaller volume of concentrated spent wash water containing the solids during washing operations is introduced into large settling pits suitably equipped with devices configured to remove separated solids from the pit in an environmentally friendly manner

This approach has a number of drawbacks. Gravity settling pits require a large area or footprint which may or may not be available at the wash facility. To maintain environmental integrity, the gravity settling pits need to be non-permeable, so they are generally constructed of concrete or steel, and thus they are costly to build and equip.

Settling pits also pose other challenges, not the least of which is the potential for generating odors due to the build-up microorganisms in the accumulated spent wash water. In certain applications, the settling pit may be charged with microorganisms that break down one or more compounds present in the spent wash water. The microbial growth in the pit must be regulated to assure proper function of desirable microbes and to prevent growth of undesirable microbes that can impair pit function and contribute to odor production.

Thus it would be desirable to provide a method and device that can produce treated water from facilities, such as truck vehicle wash facilities, where a significant amount of solids are separated or generated as waste solids in wash water and/or where the treated water quality is suitable for water reuse, and/or where the waste solids from treating the water are managed at the lowest practical complexity, footprint, and cost.

### SUMMARY

The present disclosure is directed to method for treating solids-containing waster and producing usable process water from the solids-containing water, the process includes the steps of hydraulic classification, wherein the hydraulic classification step removes fine sand and small particles from the process water to be treated wherein such that an up flow of velocity of water plus solids promotes flocculation and agglomeration of at least a portion of the fine sand and small particulate material present in the process water.

### BRIEF SUMMARY OF THE DRAWINGS

The description herein makes reference to the accompanying computer drawings and photographs showing different embodiments and molds.

FIG. 1 is a is a process flow diagram of an embodiment of the process as disclosed herein;

FIG. 2 is a schematic diagram of an agglomeration classifier according to an embodiment of the device and process as disclosed herein;

FIG. 3 is a schematic diagram of a system according to an embodiment as disclosed herein; and

FIG. 4 is an alternate embodiment of a system according to an embodiment as disclosed herein.

### DETAILED DESCRIPTION

The present disclosure is based on the unexpected discovery that targeted management of waste solids present in spent wash water such as that generated by truck washing operations in the manner disclosed herein can produce processed water that is suitable for recycle and reuse. The process and device as disclosed herein can accomplish targeted management of process water containing waste solids according to the different characteristics of the solids; i.e. by the particle size and/or particle density of the solids component. It has been found that the method and devices disclosed herein can effectively produce processed water that can be suitable for recycle and/or reuse. The process and device as disclosed herein can minimize capital cost for waste solids management equipment, and reduce on-going operating costs due to wear and tear on associated of solids handling equipment, as well as expenditures for chemicals, and solids disposal.

In the process as disclosed herein, solids are separated primarily according to particle size and secondarily according to particle density, so the solids can be more easily removed from water. The removed solids are then thickened and dewatered. The process as disclosed herein includes at least one classification step to remove fine sand and smaller particle sizes from the spent water in a classifier device to promote flocculation and classification. In the classifier device employed, up flow velocity of water, together with any coagulant and/or flocculent that may be optionally introduced into the spent wash water, plus solids present in the classifier operate to retain fine solids that collide and enmesh with newly introduced solids that are present subsequent volumes of wash water later introduced into the classifier to cause agglomeration. The larger effective diameter of the resulting agglomerated particles causes the agglomerated particles to settle more rapidly that non-agglomerated material. The settlement action of the agglomerated particles causes them to seek at least one lower depth in the agglomeration classifier vessel that is closer to the base of the classifier. The agglomerated particles located at a given depth can be collected and removed for dewatering. Segregation of particles according to their respective sizes enables each of the largest, intermediate size, and smallest solids to be thickened and dewatered separately. This allows for lowest cost dewatering with lowest practical water content.

Particulate versus Dissolved Solids: Solids material can be present in the spent wash water as either particulate solids or dissolved solids. Particulate solids, as that term is used in this disclosure, are solid materials that are insoluble or only partially soluble in water and are amenable to removal by a suitable filtration process or processes. In contrast with particulate solids, soluble solids, as that term is employed herein, are materials that are dissolved or partially dissolved in water and cannot be effectively separated by filtration. The process and device disclosed effectively provides for the manage solids materials that the process as disclosed herein primarily addresses. The process and device disclosed herein also provides for the management of select soluble solids such as dissolved iron as well as the treatment and handling of materials such as dissolved or solubilized organic compounds such as petroleum-derived hydrocarbons in a way that permits at least a portion of the treated spent wash water to be reused in the wash facility for one or more iterations.

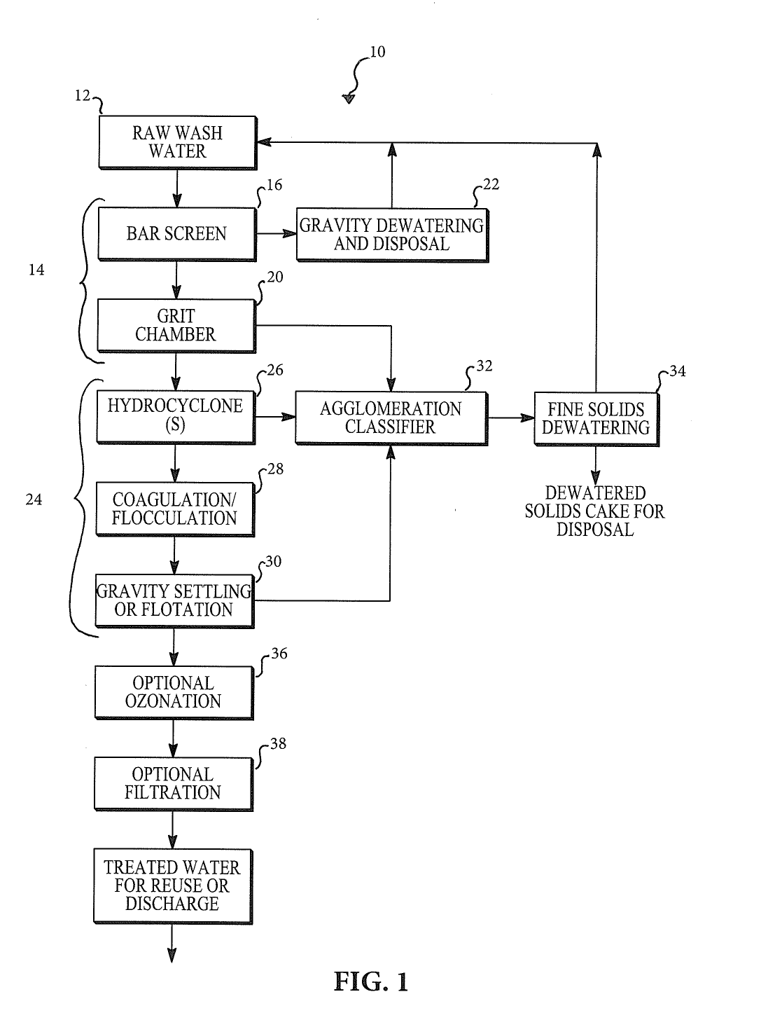

FIG. 1 is a process diagram depicting an embodiment of the process as disclosed herein. In one embodiment of the process as disclosed herein, an aqueous process stream derived from spent wash waster that has been used in operations such as vehicle washing operations. Non limiting examples of vehicle washing operations include truck washing operations, as well as various other vehicular washing operations that can be carried out using automated or semi-automated washing operations. In the process 10 as presented in FIG. 1, raw wash water is collected as at reference numeral 12. Raw wash water can be collected in a suitable holding tank or holding tanks if desired or required. It is also considered to be within the purview of this disclosure that the process and device 100 can be configured to receive raw wash water in a continuous manner

Raw wash water can be transferred as a process stream through any suitable conduit or other transfer mechanism to introduce the raw wash water as an aqueous process stream into contact with a separation zone that is configured to remove a first solids portion from contact with the aqueous process stream. The first solids portion that is removed is composed of solids debris that have a diameter of greater than ½″ diameter (the largest solids, “solids debris”) that can be separated from the water in the aqueous process stream with minimal energy input and generally with no chemical addition. The separation zone 14 includes means for removing solids debris. The separation zone 14 can include one or more devices 16 etc configured to remove the solids debris from contact with the process stream. Non-limiting examples of solids removal devices that can be employed to remove solids debris from aqueous process water stream include bar screens, grit chambers, and either coarse or fine stationary or moving screens. The devices 16 in separation zone 14 can be operated in a way that the first separated solids potion that are separated solids removed from the separation zone 14 in either a continual or periodic manner It is also contemplated that removal of solids debris that make up the first solids portion from one or more of the various devices in the separation zone 14 can function independently from one another such that, certain devices function continually and some function periodically to remove collected first solids portion material from devices such as bar screens 16, grit chambers 20, screen faces not shown) or the like. The specific solids removal devices that are employed can be positioned to sequentially remove the material that makes up the first solids portion. In the embodiment depicted, process stream exposure to at least one bar screen is followed by exposure of the process stream to at least one grit chamber 20. The process stream is maintained in contact with the various devices in the separation zone for an interval sufficient to remove solid material having an average particle diameter greater than 0.5 inches from contact with the process stream. The first portion of solids that is separated from the process stream is collected in the various devices in the separation zone 14. The solids that collect in the device(s) present in the separation zone can be removed from the associated device as desired or required. Removed solids can then be dewatered by suitable processes. Non-limiting examples of dewatering processes include gravity drainage and the like.

The separated first solids portion can be analyzed for contaminant make up. Depending on the nature of the initial process water, it is contemplated that the dewatered first solids portion may be suitable for disposal or reuse in an environmentally appropriate manner. Depending on the level and make up of any associated contamination present in or with the first solids portion, in particular, the presence or absence of oil or other petroleum hydrocarbons, the solids debris that makes up the first solids portion can be managed as clean fill or trash.

Compared to smaller solids particles that remain in the process steam after contact with the separation zone 14, (i.e. those having particle sizes less than ½″ diameter), solids debris in the first solids portion having diameters greater than ½″ diameter have a relatively small specific surface area (surface area/volume). It has been discovered that contamination levels associated with the solids (for example petroleum hydrocarbon contamination) bear relation to the surface area of specific particles. On a mass basis, larger sized solid particles solids typically exhibit lower levels of associated contamination relative to the smaller sized particles.

In the process and device disclosed herein, the targeted isolation of solids debris based on particle size permits the collection of a solids debris segment that can be disposed of in a cost effective and environmentally friendly manner The lack of entrained organic contaminants in the solids debris means that disposal can be accomplished with fewer constraints. Environmentally friendly disposal of the first portion of solids material or debris should be less costly in many situations. It is also believed that, in certain situations, the resulting first portion of solids material and the resulting material may be amenable to a variety of recycling and reuse applications including but not limited to use as industrial fill and the like. For reasons of ease of removal from water, dewaterability, and lower contamination levels for cheaper disposal, large particles are separated, dewatered, and disposed of separately from smaller particles. Where desired or required, the step of exposing the process stream to at least one separation zone can occur prior to one or more other processing operations.

It has also been found quite unexpectedly that the first solids portion composed of waste solids of greater than ½″ diameter which are referred to as “solids debris” can be separated from the water in the process water stream with minimal or limited energy input and generally require no chemical addition or processing to accomplish separation. Non-limiting examples of devices that can be employed to remove solids debris from the spent wash water include one or more of bar screens, grit chambers, and stationary or moving screens. Devices such as stationary or moving screen, bar screens, or moving screens can include at least one mesh or other separation member. The mesh or other separation or other separation member can be configured as either course or fine. Preferably these devices are operated in a way that separated solids debris are continually or periodically removed from the bar screen, grit chamber, or screen face.

The collected solids debris can generally be dewatered by action of gravity drainage of any water that remains associated with the first solids portion. Such action removes water from the associated solids material portion as at reference numeral 22. Where desired or required, the removed water can be reintroduced into contact with the process water to be treated. Depending on the level and nature of contamination associated with the solids material in the first solids portion, the solids debris can disposed of in a suitable environmentally friendly manner Where the solids material lacks evidence of origanic contamination such as contamination with oils, hydrocarbons and the like, at least a portion of the solids material present tin the first portion the first solids portion with be managed as clean fill or trash. Non-limiting examples of material that can make up solid debris are materials such as sand, silt and clay particles. It is also contemplated that removal of the solid debris sized particles present in the first portion can be accomplished by a process that includes more than one method. Non-limiting examples of additional methods that can be used to separate debris sized particulate material include gravity settling 22 and exposing the material to hydrocylones. In certain embodiments, it is contemplated that the process of separating and dewatering solid debris sized material present in the first portion can include multiple processing steps.

Once larger solid debris sized particles are removed by physical separation, the remaining particulate solids that are smaller than silt or clay can be treated to render them amenable for separation. These smaller particles can be treated in a manner that accomplishes particle aggregation in order to facilitate separation. Without being bound to any theory, it is contemplated that the resulting larger aggregate particle size will facilitate separation from the associated water even in a confined holding vessel, thus making it practical for use in facilities such as those performing vehicle wash operations.

It has been found, quite unexpectedly that the process as disclosed herein with the initial removal of the first solids portion that is made up of larger particles, i.e. solids debris facilitated the effective subsequent removal of smaller and/or finer particles presenting the process stream. It is submitted that without such initial treatment, very fine solids that do not settle or float or exist in a condition that renders them otherwise separable from the associated spent wash water, would therefore accumulate and concentrate in the spent wash water, rendering the spent wash water component of the process stream unsuitable for recycling and reuse back in operations such as the vehicle wash station.

The process stream, upon exit from the separation zone, is composed of water and dilute suspensions of solid material in water. For dilute suspensions of solids in water, Stokes' law predicts particle settling velocity:

$$w = \frac{2 ( {ρ}_{p} - {ρ}_{f} ) g {r}^{2}}{9 μ}$$

In the Stokes Law equation above, w is the particle settling velocity, ρ is density (subscripts p indicate particle, f indicates fluid), g is acceleration due to gravity, r is the radius of the particle, and μ is the dynamic viscosity of water. For a given set of physical characteristics (density of the various solids and associated liquids, viscosity of water). Since the square of particle size governs settling velocity, the particle solids that remain in the process stream after exit from the separation zone, remain suspended in the process stream for prolonged periods of time. It has been found, quite unexpectedly that at least a portion of these fine particles can be agglomerated into larger particle solids and can be effectively separated from the water component of the process stream.

In the process disclosed herein, there are three main process parameters for removing poorly settling fine silt and smaller solids from the spent wash water present in the process stream in order to render the spent wash water suitable for reuse and/or to render the separated solids suitable for disposal. They are listed as follows: 1) the degree of particle to particle contact that is achieved in the process stream during subsequent treatment in the process disclosed herein; particularly after addition of at least one agglomeration promoting agent such as a coagulant and/or flocculent; 2) the configuration and/or capacity of one or more separator(s) to separate the agglomerated solids that are produced from the bulk volume of waste water being treated, typically accomplished by gravity settling, flotation, or filtration—so called “solids thickening”; and 3) means employed for dewatering the resulting thickened solids to reduce the water content of the solids portion and form a stackable solid, thus lowering the mass of waste solids for disposal.

In the process as disclosed herein, after the process stream exits the separation zone 14, the process stream can be subjected to one or more actions that increase particle-to-particle contact in among the solids material present in the process stream. In the embodiment depicted in FIG. 1, after removal of at least a part of the first solids portion, the process stream can be subjected a solids aggregation process as at reference numeral 24 to produce at least one second solids portion that is amenable to separation from the aqueous process stream. The solids aggregation process includes at least one of the following: increased particle to particle contact within the process stream, density reduction of aggregated particles, settlement of aggregated particles relative to the aqueous process stream.

Particle/Particle Contact: Commonly, solids/solids contact in the water that makes up the process stream can be produced and/or enhanced by promoting convoluted fluid flow and enhanced turbulence as by mechanical mixing means such an impeller mixer, an in-line static mixer, or by air bubbles in water as with fine bubble aeration or gas flotation. Solids/solids contact in the water of the process stream can also be provided by counter-current flow of solids in water such that the down flow of solids due to gravity settling is met by up flow of solids by water flow. This can be accomplished by various means and devices including but not limited to hydraulic classifiers and the like.

In the process as disclosed herein the process stream can be subjected to mechanical mixing after the first solids portion has been separated from contact with the process stream. In the process as disclosed in FIG. 1, the process stream can be subjected to hydrocyclonic action as at reference numeral 26. Mechanical mixing can be augmented by the position of the one or more hydrocyclone discharge mechanisms that discharge into in a first buffer tank. Tangential flow of the process stream discharge into the associated discharge tank creates swirl mixing so no external impeller mechanical mixer is required, simplifying contact between particles. Wherein desired or required, it is contemplated that mechanical mixing can be employed instead of or in addition to the hydrocyclonic action. Mechanical mixing can be accomplished by impellers, mixing blades or the like.

Coagulation and Flocculation of Hydrocyclone Overflow: Where desired or required, the particles can be aggregated by adding chemicals that cause their coagulation and/or flocculation as at reference numeral 28. The resulting agglomerated solids have a larger effective size than their constituent solid particles. The resulting agglomerated solids can be more readily separated from water in the process stream than the smaller solids present prior to agglomeration. However, compared to non-agglomerated particulate solids of similar size, chemically agglomerated solids may be more difficult to separate from water. Without being bound to any theory, it is believed that the agglomerated particles exhibit a density that can be less than similarly sized solid particles. It is also believed that the added flocculant(s) and/or contaminant(s) can interact with non-solids contaminants present in the process stream to sequester the non-solids contaminants for ultimate removal. Non limiting examples of such contaminants are emulsified petroleum products that may exist in the process stream in a free state and/or in connection with solids present therein.

Solids Thickening: Separating the resulting agglomerated solids in the aqueous process stream from the bulk volume of the spent wash water that is under treatment can be achieved in the thickening section of gravity clarifier(s) as at reference numeral 30. As disclosed herein in the at least a portion of the resulting agglomerated solids are subjected to at least one floatation process. Non-limiting examples of suitable floatation processes include gas flotation or dissolved air flotation systems, followed by filtration, and/or by hydraulic agglomeration.

Hydraulic Classification: I certain embodiments of the process as disclosed herein, the solids remaining in the process stream than exits the separation zone 14 can be aggregated according to particle size can be accomplished using a hydraulic classifier as at reference numeral 32. In the process as depicted in FIG. 1, at least a portion of the process stream is diverted to the classifier device upon exit from the hydrocyclonic process, while an additional portion of the process stream in subjected to the coagulation and/or flocculation step and to gravity settling and or floatation. Once the material that is separable by settling and/or floatation have been removed, the remaining process stream, which may exhibit slurry characteristics can be introduced to the agglomeration, clarification step.

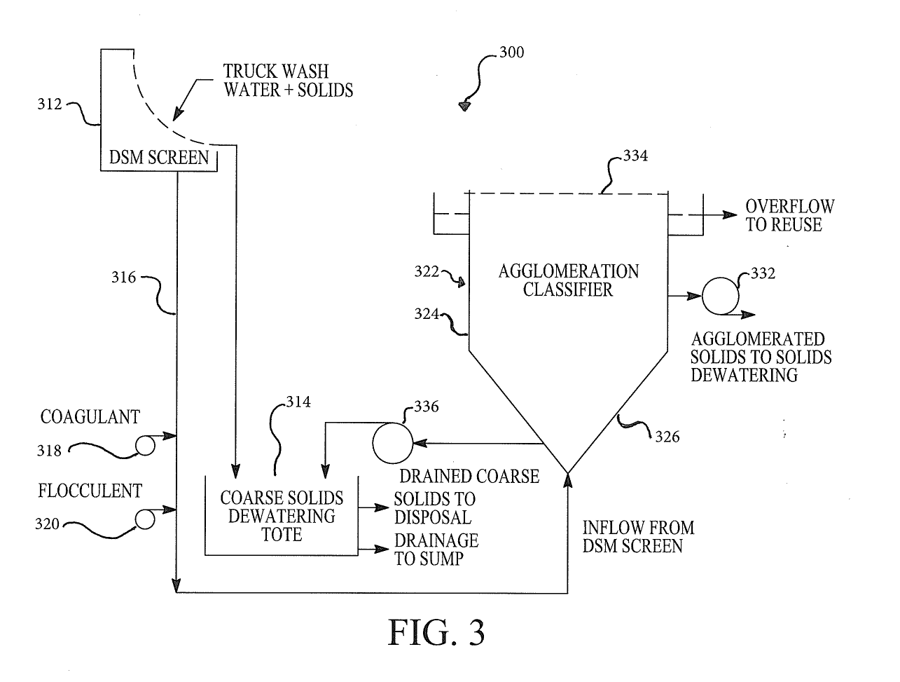

As used herein, the term “hydraulic classifier” is defined as a tank or vessel that includes at least one fluid introduction inlet that facilitates a fluid flow that starts at or near the bottom of the tank and flows upwards to flow out of the top of the tank. A schematic depiction of a non-limiting example of a hydraulic classifier 200 is depicted in FIG. 3. According to Stokes Law described above, the upwards fluid velocity of aqueous process fluid traveling through the tank 210 selects the particle size that remains in the tank such that an elevated process fluid flow velocity can wash out fine solids and resulting in only large and dense solids particles remaining in the classifier, whereas a reduced up flow velocity of introduced process fluid results in both large and small particles remaining in the classifier. For tanks of variable horizontal cross sectional area such as a conical bottom tank or a baffled tank, particles are retained in the hydraulic classifier are located according to their particle size relative to the up flow velocity at that position in the tank. Thus a conical tank that is operated as a hydraulic classifier will retain larger particles in the base of the tank and smaller particles in the top of the tank. Similarly, a rectangular tank where baffles divide the tank into a smaller cross sectional area section followed by a larger cross sectional area and that is operated with liquid up flow as a hydraulic classifier will retain larger particles in the base of the small section of the tank and smaller particles in the larger section of the tank.

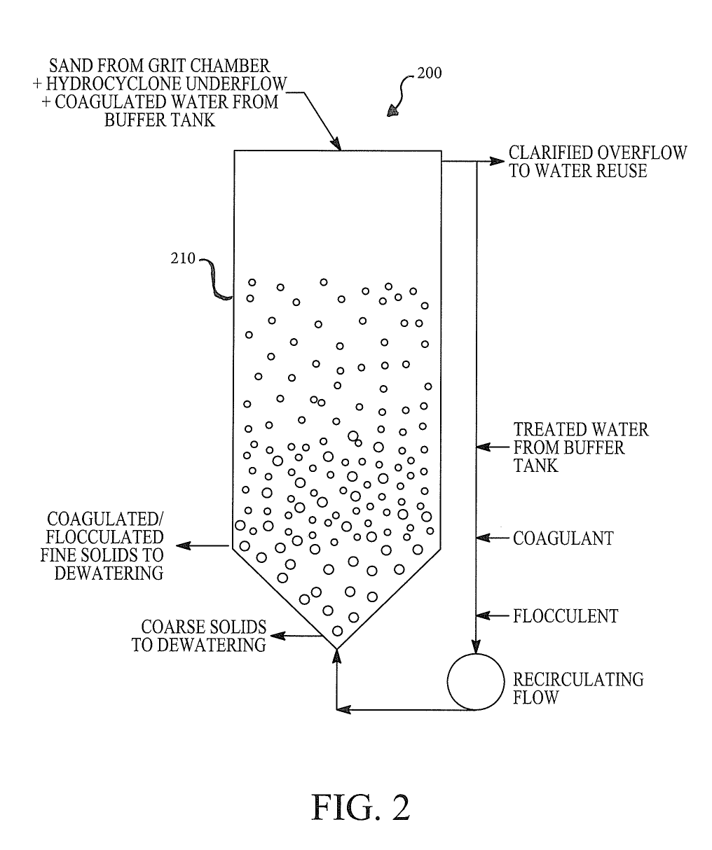

Agglomeration Classification: In the hydraulic classifier thickening step as employed herein, chemically coagulated solids transported by up flow of the influent process stream composed of spent wash water are enmeshed by solids that have been retained in the classifier and held in suspension because their settling velocity is in equilibrium with the up flow velocity in the classifier. This solids/solids contact results in a solids agglomeration phenomenon that causes, at least in part, formation of larger particles that settle in the tanks at a faster rate. This process continues as more water and solids flow to the classifier, growing particle size through agglomeration, and lowering the position of these agglomerated particles in the classifier. The agglomerated particles that are formed ultimately migrate to the base of the classifier where they are removed for disposal. The term “agglomeration classification” is employed to describe this process. A non-limiting example of an agglomeration classifier is depicted in FIG. 2.

The rate and process of solids thickening using an agglomeration classifier is controlled by one or more of the following: (1) up flow velocity of the process stream in the clarifier, (2) type and concentration of chemical coagulant(s) and/or flocculent(s) introduced into the process stream, (3) the solids loading rate of the process stream, (4) concentration of solids present in the classifier, (5) the removal rate of solids from the classifier, (6) differences in the cross sectional area throughout the height of the classifier. It is also contemplated that factors that affect the viscosity of the spent waste water can be modified to affect performance and effectiveness of the device and associated process. Non-limiting examples of factors that can affect viscosity of water include water temperature, pressure, and the like. Other factors include, but are not limited to, pH and redox potential that affect the performance of chemical coagulant(s) and/or flocculent(s). These factors impact classifier thickening performance to manage solids from sources such as vehicle wash facilities.

Solids Dewatering: Solids removed during that are introduced in the process stream as a result of truck washing activities need to be separated from spent wash water in the process stream so the water can be reused. Separated solids need to be dewatered at minimal cost, while also minimizing the cost for solids disposal. While these needs may be obvious, reliably achieving effective solids separation and solids dewatering under variable conditions at reasonable cost has so far been elusive.

Spent wash water solids that require separation and dewatering can range from oversize debris such as rocks, gravel, wood chips, and waste plastic, to coarse and fine sand, silt, and clay. Additionally, road tar, diesel fuel, motor oil, gasoline, engine coolant, antifreeze, and truck wash detergents may be associated with some or all these solids. Since soil is part of the solids mix, soil microorganisms can also be present that can to convert one or more constituents of spent wash water in the aqueous process stream into slime and odorous compounds such as hydrogen sulfide as well as volatile organic acids. Such contaminants complicate solids management and add to disposal cost.

In the process and device as disclosed herein, a wide range of solids particle sizes can be effectively separated and dewatered as distinct portions or cuts composed of coarse solids, sand, and fine solids. In the process disclosed herein, coarse solids are removed initially. This minimizes abrasive wear on mechanical equipment, in particular equipment with moving parts such as those associated with removal and recirculation of the treated wash water in the process stream. This can be accomplished be one or more suitable means. ****** In the embodiment depicted in the FIG. 3, stationary sloped self-cleaning screens such as DSM screens can be employed to remove coarse solids such as rocks, gravel, wood chips, waste plastic, and coarse sand. For example, the abrasiveness of sand and grit can cause excessive wear of moving parts such as a drag chain, requiring frequent parts replacement. In contrast, the lack of moving parts of DSM screens and their self-cleaning and non-fouling nature result in a long wearing, robust and low-maintenance devices. Separated oversize debris and coarse solids, with sand, silt and clay pass through the screen, readily dewater by gravity drainage.

Coarse to medium sand can be separated by hydraulic classifiers, gravity settling chambers, or hydrocyclones. In situations where coarse to medium sand is not combined with fine sand, silt or clay, the coarse to medium sand can readily dewater by gravity drainage along with screened coarse solids.

Fine sand, silt, and/or clay materials present in the process stream are not easily separated in the first separation zone 14 by screens and other mechanical devices employed therein. The screen mesh size required to collect fractions of particles having an average particle size less than 0.5 inches, and, more particularly less than 0.25 inches, would include screen opening sizes that would result in plugging and fouling of the treatment device. In the process 10 as disclosed herein, at least one hydraulic classification step 32 is employed and is employed to address and remove at least a portion of second solids portion that that includes fine sand, silt, and clay particles. Where desired or required, at least a portion of the process team containing the second solids portion can be contacted with coagulant(s) and flocculent(s) that have been added into the water management system to provide a robust way to segregate fine solids. Coagulant(s) and flocculent(s) added to at least a portion of the process stream agglomerate fine solids together to facilitate their separation.

Coarse and fine sand material separated from the process stream in the agglomeration classification step 32 can be pumped as a side-stream from the classifier to a suitable waste solids receptacle where the solids can be subjected to a dewatering step as at reference numeral 34. Non-limiting examples of suitable dewatering process include gravity drainage, filter pressing and the like. It is also contemplated that at least a portion of the second solids portion that is made up of silt and clay material can be pumped as a side-stream from the classifier unit or units to a suitable solids dewatering device. Non-limiting examples of such dewatering devices include various plate and frame filter presses or centrifuge(s). Since the hydraulic classification step segregates particles according to their respective settling velocity, it is contemplated that one or more side streams can be removed from the classifier at locations that maximize the percentage of particles of given characteristics such as particle size and/or particle density and/or agglomerated particle size and/or agglomerated particle density. The flow rate of a give side stream that is removing targeted particles from the classifier can be balanced with the influent flow rates to provide suitable target up flow velocity for particle segregation.

In the process as disclosed herein, the water that is separated from the second solids portion in the dewatering step 34 can be recycled in an environmentally suitable manner It is contemplated that at least a portion of the water that is separated during this process can be reintroduced into the process stream to induce turbulence and mixing as desired or required. In the process depicted in FIG. 1 at least a portion of the water separated in the dewatering step is admixed with raw wash water as a reference numeral 12. It is also contemplated that water separated during the process disclosed can be subjected to one or more post separation processes prior to discharge into suitable waste water discharge systems and/or reuse in various cleaning processes. Non-limiting examples of such post separation steps include ozonation as at reference numeral 36 and/or final filtration as at reference numeral 38.

An overall solids management approach using a stationary screen and agglomeration classifier is shown in FIG. 3 with an embodiment of a treatment system 300 being schematically depicted. The device 300 includes at least one screen mechanism 312 configured to separate at least a portion of the water present in the process stream introduced in treatment system 300 from solids that are also present in the introduced process stream. In the embodiment depicted in FIG. 3, at least one screen mechanism is configured as a DSM screen to permit accumulation of separated process water and transfer of course solids forming the first solids portion into a suitable dewatering mechanism such as course solids dewatering tote 314 where the first solids portion can be dewatered. The separated water portion can be discharged to a suitable sump or post treatment processing. The dewatered solids can be collected for suitable disposal or recycled use where feasible.

The water portion of the aqueous process stream from which the first solids portion has been separated can be transferred from the screen mechanism 312 via suitable conduit(s) 316. As the separated process stream transits the conduits, it can be admixed with suitable coagulant(s) and/or flocculant(s). The process stream conveying conduit is in fluid communication with one or more additive delivery devices that can deliver measured amounts of additives to the process stream. In the embodiment depicted in FIG. 3, the device 300 includes at least one coagulant delivery device 318 and at least one flocculant delivery device 320 that are positioned downstream of screen mechanism 312 and upstream of at least one solids agglomeration device such as agglomeration classifier 322.

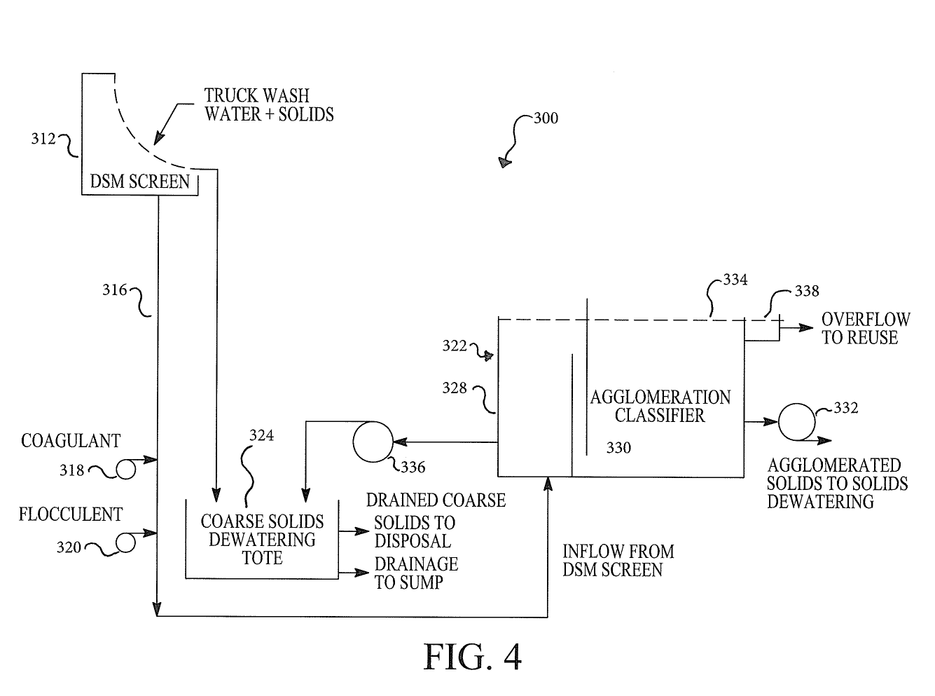

It is contemplated that, in certain embodiments, the agglomeration classifier 322 can be configured as a tank 324 with a conical bottom 326. Note that the conical bottom 326 of tank 324 of classifier 322 alternatively can be configured as a small diameter tank plumbed in series downstream with a large diameter tank, or as a single circular or rectangular tank 328 with baffles 330 to provide the same up flow velocities for particle classification (See FIG. 4).

It is contemplated that the agglomeration classifier 322 will be configured to permit agglomeration of fine particulate material and settlement of the agglomerated material based on factors such as density, mass, particle size and the like with in the process material present in the classier tank 324, 328. In the embodiments illustrated in FIGS. 3 and 4, conduit 316 is connected to the agglomeration classifier at a location proximate to the conical bottom 326 of tank 324 or lowermost portion of tank 328 such that the process stream enters the tank and is directed upwardly therefrom.

At least one solids take-off device is in fluid communication with the interior of the tank 324, 328 at a defined height relative thereto. In the embodiment illustrated in FIGS. 3 and 4, at least one upper solids take-off mechanism 332 is located at a height generally midway between the conical bottom 328 of agglomeration classifier 322 or the lowermost portion of tank 328 and the top 334 of agglomeration classifier 322. The device 300 also includes a lower solids take-off mechanism 336 in fluid communication with the agglomeration classifier 322 at a location below the at least one upper solids take-off mechanism 332 and generally proximate to the lowermost portion of the agglomeration clarifier 322. The at least one lower solids take-off mechanism 336 is in fluid communication the solids dewatering tote 314, so as to communication the solids removed from the agglomeration classifier 322 with the dewatering mechanisms employed with solids initially separated by screening mechanism 312. The at least one upper solids take-off mechanism 332 can be in communication with suitable post-treatment mechanisms to process the associated solids prior to reuse or disposal.

The agglomeration clarifier 322 also includes at least one overflow mechanism 338 that permits clarified water to exit the agglomeration classifier and be routed for reuse with in the associated washing system and/or recycle in the process water treatment system disclosed herein.

### Filtration vs. Gravity Settling vs. Agglomeration Classification

Filtration: Where desired or required, the initial concentration of solids contained in the process stream can be sufficiently elevated to produce a slurry. If a slurry of solids derived from spent wash water collected from washing trucks was retained so the solids themselves served as a filter to remove subsequently introduced solids, and this slurry was pumped from the top to bottom of a vessel as an “auto-filter”, the pressure drop would be extreme due to a relative abundance of small particles, and the stickiness of chemical coagulant, flocculent, and oil contaminants. This would restrict the filter bed depth of retained solids, as well as volumetric loading to the down flow filter. Additionally, removing compacted filtered solids for dewatering would be comparatively mechanically complex, requiring an auger or other solids conveyance equipment, adding to capital and operating cost.

Gravity Settling: Free settling describes the behavior of a single spherical particle in an infinite fluid. The free settling velocity is a net result of the gravity force less the buoyancy force and the drag force. Hindered settling occurs where a high concentration of particles in a vessel of water slows the downward movement of particles by increasing the effective viscosity of the mixture. Under hindered settling conditions as can occur when a clarifier is used, solids in the spent wash water settle at different rates. Typically, gravity settling in a clarifier involves horizontal movement of water towards an overflow weir with solids settling by gravity at approximately a right angle to horizontal fluid flow. The largest and heaviest solids readily settle to the base of the clarifier. Intermediate size particles gravity settle more slowly in the clarifier, without counter flow of solids with liquids, providing little opportunity for solids agglomeration for faster settling and better thickening. The smallest and the lightest solid particles settle slowly and remain in the upper section of the clarifier with only minimal contact with other particles, thus minimizing opportunities for solids agglomeration and improved settling. The result is that the clarifier overflow contains a higher concentration of solids than is desirable, and that the concentration of solids available for dewatering is less than desired, thus increasing the volume of solids slurry to be dewatered, requiring larger volumetric capacity as well as more coagulant and/or flocculent for solids dewatering.

Agglomeration Classifier: In contrast with conventional gravity clarifiers such those used at municipal wastewater treatment plants, when the agglomeration classifier as disclosed herein is used for treatment of spent wash solids, a large concentration of solids in water is intentionally retained in a vessel that has a controlled water up flow velocity from the base of the vessel to over flow at the top of the vessel. Since the up flow velocity results in expansion rather than compaction of solids, the pressure drop across the agglomeration classifier is close to zero. The agglomeration classifier vessel typically may be taller than it is wide, and preferably has a conical shape in the bottom of the tank.

Unlike hindered settling of solids in a clarifier, solids in the spent wash water in the agglomeration classifier flow upwards at different rates due to the range of particle sizes initially present in the process stream. This results in collisions and enmeshing of solids so the solids are retained in the agglomeration classifier and do not readily exit with the overflow. A high concentration of accumulated solids in the classifier results in many collisions between solids, leading to coagulation/ flocculation of particles. As particle size increases, the solids settling rate also increases. This results in the largest solids self-locating in the base of the classifier where they can be removed by pumping action and transferred to a suitable solids dewatering device such as a plate and frame filter press or centrifuge.

Unlike a simple hydraulic classifier, the agglomeration classifier as disclosed herein is dynamic with respect to the size of particles. A wide range of particle sizes is fed to the agglomeration classifier. The largest and heaviest particles flow to the bottom of the classifier where they are pumped to solids dewatering devices. Intermediate sized solids and the smaller sized solids have a larger specific surface area (surface area per volume of solid). They will have a greater proportion of coagulant and/or flocculent associated with them than the larger sized solids and are more likely to further their agglomeration with other additional solids available in the classifier. By growing the overall particle size through inter-particle collisions, the up flow velocity that would be required to keep these solids in suspension increases. Assuming no increase in actual up flow velocity, the position of agglomerated solids in the agglomeration classifier lowers, eventually to the base of the classifier where the solids are pumped from the classifier to suitable dewatering device(s).

The agglomeration classifier may offer a number of advantages over simple gravity settling or clarification. These may include one or more of the following as outlined. By setting the up flow velocity, the agglomeration classifier can select for particle size that is either retained or removed. The up flow velocity provides counter-current contact of up flowing solids and water with gravity settling of retained solids. This results in more collisions and thus more opportunities to agglomerate solids, so the solids settle faster in the agglomeration classifier and can be removed for dewatering. The agglomeration classifier offers more flexibility in operations compared to a clarifier that operates simply by the unchanging forces of gravity. For example, by increasing or decreasing the up flow velocity by changing the pumping rate, the retained particle sizes can be increased or decreased process performance can be modified as desired or required. Additionally, by changing the cross sectional area in the agglomeration classifier or by operating more than one classifier with a succession of vessels each with larger horizontal cross sectional areas in series, specific particle sizes can be selected.

### Agglomeration Classifier Experimental

A sample of mud collected from truck washing operations was tested using a lab scale hydraulic classifier. The proportion of fine silt and clay appeared to be in the neighborhood of 90% or greater by dry mass. Coarse and fine sand constituted less than 10% of the dry mass of solids in the sample.

Coarse and Fine Sand: During hydraulic classification, fine solids were washed upwards and coarse sand promptly migrated to the base of the classifier at a water up flow velocity as high as 25 cm/s. Fine sand was retained in the classifier above the coarse sand at an up flow velocity of 1.6 cm/s. Adding coagulant and flocculent to the solids slurry resulted in no apparent impact on hydraulic classification of coarse and fine sand. Once separated from fine silt and clay, coarse and fine sand was available to be pumped from the classifier to a solids bin for gravity drainage and disposal.

Silt and Clay: Without addition of coagulant and flocculent, at up flow velocities ranging from 0.10 cm/s to 1.6 cm/s, fine silt and clay gradually washed out of the classifier without significant retention of these solids in the classifier. In contrast, following coagulant and flocculent addition to the solids slurry, a critical up flow velocity for fine solids of 0.13 cm/s was noted: a band of flocculated fine solids accumulated in the classifier above fine sand that was suspended above the coarse sand. By adding coagulant and flocculent, fine silt and clay solids were flocculated and were retained in the classifier, increasing in floc size, migrating to a lower position in the classifier above the fine sand. Once separated from coarse and fine sand, flocculated silt and clay can be pumped from the classifier to a solids dewatering device such as a plate and frame filter press or a centrifuge for dewatering and disposal. By separating coarse solids from silt and clay, pumping the slurry of flocculated fine solids is less abrasive.

Within their segregated bands of sand and flocculated silt, smaller particles in the classifier demonstrated a circulation pattern. Solids moved upwards in the center of the classifier and circulated downwards along the outside wall of the classifier. Whereas coarse sand moved very little, fine sand showed minor circulation within the classifier. Flocculated fine solids showed a high degree of circulation in the classifier, presenting multiple opportunities for inter-particle collisions, leading to flocculation and larger sized agglomerations that are more amenable to separation from the bulk volume of the wash water and for dewatering.

### Process Overview

The method for effectively managing solids derived from truck wash solids as disclosed herein is to dewater separated solids in an efficient way, such that large solids can be mechanically removed using simple equipment and dewatered by gravity drainage, and whereas smaller solids can be removed by pumping to a dewatering device. It has been found unexpectedly that this can be achieved by maintaining a constant and high solids concentration of smaller solids in the agglomeration classifier while continually removing as many solids as are fed to the classifier, avoiding either increases or decreases in retained solids. When this occurs, removal and dewatering of large solids is efficient, wear of mechanical removal equipment is minimal, and smaller agglomerated solids are readily removed and dewatered via a plate and frame filter press or other dewatering device.

Alternatively, dumping truck wash solids and water into a vessel or hopper for gravity settling to be drawn off the bottom creates bridging of solids so they cannot be easily removed, and this leads to solids buildup in tank vessels. Instead, up flow classification allows heavier solids to quickly separate from finer solids. These large solids can be continuously or semi-continuously removed from the classifier by a screen, drag chain, or other mechanical solids removal equipment. Larger solids are readily and inexpensively dewatered by simple gravity drainage of removed solids.

Smaller solids are not suitable for removal by a screen, drag chain or other mechanical solids removing device because of their small size and the disturbance caused by such mechanical devices causes re-suspension of smaller solids. Up flow enables smaller solids to coagulate/flocculate in the agglomeration classifier until they are large enough and suitable for pumping to a solids dewatering filter press.

Too few solids in the agglomeration classifier result in too few inter-particle collisions and thus less agglomeration than is needed to form larger particles that dewater well. Too many solids in the classifier occupy too much volume, resulting in an increased up flow water velocity that exceeds the critical washout velocity of small particles. This results in reduced effectiveness of solids separation, leading to solids escape with the classifier overflow.

The key to effective solids dewatering is to maintain a constant inventory of solids in the agglomeration classifier. The amount of large solids should be maintained as low as practical and the concentration of smaller solids has an optimum as described elsewhere in this document.

When solids that are fed to the agglomeration classifier accumulate to excessive levels, the solids may become bridged due to insufficient separation of large particles from small particles due to insufficient up flow. Up flow circulation removes smaller solids that otherwise fill interstices that cause bridging of solids. Without smaller solids, larger solids can be inexpensively dewatered by gravity drainage. By removing larger solids, dewatering of smaller solids is facilitated by avoiding abrasion on dewatering pumps caused by large solids, and by minimizing the total quantity of solids to be dewatered by a filter press.

### Process Description

The recycled wash water and solids management system is described as follows:

First, separation of solids debris: all vehicle wash water passes through a ½″ bar screen or auger screen to capture large trash and rocks. Water flows through one or more grit chambers and trash screen(s). Sand and silt and larger particles are retained in the grit chambers to be pumped to the coarse screen (for example, a DSM screen). Screened liquid discharge from the coarse screen enters the agglomeration classifier. Particles smaller than sand and silt size are pumped to the hydrocyclone(s).

Once the solids debris are separated from the wash water, the debris are removed and dewatered by gravity drainage and sent to disposal.

Following coarse screening, screened wash water enters one or more grit chambers where heavy solids that settle by gravity to the bottom of the grit chamber(s) are pumped to the coarse screen. Screened liquid discharge from the screen enters the agglomeration classifier on a continuous or periodic basis for gravity drainage.

Pumps transfer overlying water and fine solids from grit chambers through one or more hydrocyclones to separate solids that are as small as fine sand and as well as silt solids from the wash water.

Hydrocyclone overflow is discharged to the first of at least two buffer tanks, connected in series.

Coagulant and/or flocculent are added by a chemical metering pump to water that is pumped from the last of the buffer tanks and recirculated back to the first of the buffer tanks. Flocculation aids gravity settling of solids that are periodically discharged from the bottom of each of the buffer tanks to the agglomeration classifier.

A cationic coagulant such a positively charged polymer or a cationic coagulant such as alum (aluminum sulphate) or iron sulphate or dissolved aluminum or steel anode from electrocoagulation can be used to agglomerate negatively charged fine particulate solids such as mud and emulsified oil and grease in the wash water, so the coagulated contaminants can be separated from the treated wash water. Note that inorganic cationic coagulants containing chloride such as aluminum chloride or iron chloride may not be suitable for multiple water reuse applications due to elevated concentrations of chloride upon recycle causing corrosion of equipment, trucks, and concrete. Materials such as aluminum sulphate or iron sulphate have limited suitability for water reuse due to elevated concentrations of sulphate. Elevated levels of sulphate, when consumed by sulphur reducing bacteria, form sulphide which can be a source of offensive and poisonous odors, as well be being available to precipitate metals ions present in the process stream, and cause corrosion of equipment, trucks, and concrete. Electrocoagulation or organic polymeric coagulants that do not contain either sulphate or chloride may be used to avoid the negative effects of using inorganic coagulants. In cases where coagulated solids are small in size and thus are slow to separate from water, a negatively charged polymer can also be added to flocculate the overall positively charged agglomeration of solids and thus increase the size of particles and consequently their rate of separation from water.

As the mud level varies in the wash water, the pumping rates of the coagulant and/or flocculent are correspondingly varied in order to maintain water quality.

Optionally, gravity settling, filtration, or flotation can be used to separate the chemically conditioned agglomerated solids. Separated solids are directed to the agglomeration classifier for added thickening and then dewatering and disposal.

Discharge from the buffer tank of coagulant/flocculent treated water is fed to the agglomeration classifier for solids/solids contact and resulting in an increased size of the agglomerated solids. This promotes thickening in the agglomeration classifier for subsequent dewatering in the plate and frame filter press.

Sand, silt, and clay particles in the hydrocyclone(s) underflow are directed to the agglomeration classifier for separation and removal.

In the agglomeration classifier, the up flow velocity is set according to the wash out velocity of the particles. The up flow velocity should be large enough so coarse solids accumulate but do not compact in the classifier cone, thus enabling continuous removable of coarse solids by a pump, drag chain, or auger. The up flow velocity should be small enough to maintain a high and stable concentration of solids in the classifier to enmesh fine sand, silt or clay particles which are retained in suspension in the agglomeration classifier rather than exit with the classifier overflow back to the recycled water system.

Thickened solids from the agglomeration classifier are pumped to a plate and frame filter press or other solids dewatering device for solids dewatering. Dewatered solids from the solids dewatering device are periodically discharged to a filter cake bin for disposal.

Optionally, ozone is injected into treated wash water that is circulated between one or more buffer tanks to treated wash water to minimize odors arising from hydrogen sulphide, to arrest growth of microorganisms that form slime, and to form iron precipitates that may be separated from water. Ozone is prepared on site by removing nitrogen from air and then passing the resulting oxygen gas past electrical plates that are separated by high voltage.

Filtrate from the plate and frame filter press flows back to the grit chamber to be treated once again.

Treated wash water is reused to wash trucks, where the reused and treated water is again collected and pumped to coarse screening for repeated treatment and reuse.

Although embodiments have been described above with reference to the accompanying drawings, those of skill in the art will appreciate that variations and modifications may be made without departing from the scope thereof as defined by the appended claims.

What is claimed is:

1. A method for treating solids-containing water, comprising the steps of:
collecting a solids containing process stream from at least one water production source, the water production source including at least at least one washing facility for an automotive, locomotive or off-road vehicle any combination of the foregoing, wherein the solids containing aqueous process stream comprises inorganic solids, organic-containing solids and water;
introducing the collected solids-containing aqueous process stream into at least one first separation zone, the first separation zone configured to remove a first solids portion from contact with the aqueous process stream, wherein at least a portion of the first solids portion is inorganic solids;
after removal of the first solids portion, subjecting the process stream to at least one solids aggregation process, the at least one solids aggregation process producing a second solids portion that is amenable to separation from the aqueous process stream, wherein the solids aggregation process includes at least one of the following: increased particle to particle contact within the process stream, density reduction of aggregated particles, settlement of aggregated particles relative to the aqueous process stream;

2. The method of claim 1 wherein the first solids portion has an average particle diameter greater than 0.5 inch.

3. The method of claim 1 wherein the solids aggregation process comprises directing the process stream through a region of convoluted fluid flow and enhanced turbulence, the enhanced turbulence produced by at least one of mechanical mixing, in-line static mixing, aeration.

4. The process of claim 3 wherein the solids aggregation process also includes the step of hydrocyclone discharging.

5. The method of claim 1 wherein the solids aggregation process comprises hydraulic classification, wherein the second solids portion produced by the hydraulic classification includes silica particles and particles having an average diameter less than 0.5 inches, wherein the hydraulic classification comprises the step of producing an up flow in the aqueous process stream, the up-flow having an up-flow velocity, wherein the up flow velocity of aqueous process stream water in the classifier is sufficient to promote flocculation and classification of the second solids portion.

6. The method according to claim 5, wherein the up flow velocity in the agglomeration classifier is in equilibrium with a settling velocity of the second solids portion present in the classifier, resulting in solids suspension in the classifier to aid agglomeration of solids to form larger solid particles that readily settle, wherein said agglomeration continues as additional volumes of aqueous process stream water containing additional solids are introduced into the classifier, wherein tin the introduction of additional process results in growth in particle size of the agglomerated particles and lowering of the position of the agglomerated particles in the classifier; and collecting the agglomerated particles containing the second solids portion when the agglomerated particles of the second solids portion reach a lowest region of the agglomeration classifier; and removing agglomerated particles from the classifier for dewatering and disposal.

7. The method of claim 6 further comprising the step of introducing at least one agglomeration aid to the aqueous process stream after removal of the first solids portion, the agglomeration aid being selected from the group consisting of coagulants, flocculent chemicals and mixtures thereof, wherein the second solids component is present in the aqueous process stream as a solid slurry.

8. The method according to claim 7, wherein coagulant and flocculent chemicals are added to the solids slurry to agglomerate particles and thus increase average particle size of the secid solids component to a size sufficient for efficient liquid/solid separation in the agglomeration classifier followed by solids dewatering.

9. The method of claim 8 wherein the coagulant is a cationic coagulant selected from the group consisting of positively charged polymers, inorganic coagulant, and mixtures thereof, wherein the inorganic coagulant includes at least one of: aluminum sulphate, aluminum chloride, iron sulphate, iron chloride, a dissolved metal such as dissolved aluminum, dissolved iron or other dissolved metal.

10. The method of claim 9 further comprising an electrocoagulation step wherein the electrocoagulation step agglomerates silt, clay, suspended solids, petroleum hydrocarbons, and other contaminants in the water such that coagulated contaminants are separated in the agglomeration classifier from treated water.

11. The method of claim 8 wherein the coagulant is a negatively charged polymer and wherein the negatively charged polymer is added in order to flocculate coagulated solids to cause their agglomeration, thus increasing the size of agglomerated particles to increase their settling velocity and aid their separation in the agglomeration classifier from water.

12. The method of claim 1 wherein at least a portion of the collected solids-containing process stream introduced into at least one first separation zone, passes through a solids separation zone on a continual or periodic basis, wherein the separation zone includes at least one separation device, the separation device including one of the following: one or more grit chambers, bar screens, auger screens, or other stationary or moving screens to separate solids, the separation device configured to remove solids having an average diameter greater than 0.5 inches.

13. The method of claim 12 further comprising the step of dewatering the separated solids, the dewatering step comprising gravity separation.

14. The method according to claim 3, wherein the solids aggregation process proceeds in an agglomeration classifier, the agglomeration classifier comprising a tank, the tank having a bottom, a top and a fluid flow inlet with liquid flow inlet located at or near the bottom of the tank and exiting at or near the top of the tank, the tank configured such that process fluid in introduced at an upwards fluid velocity sufficient to suspend at least a portion of the solid particles continued in the process stream, wherein fluid velocity proximate to the top of the tank washes out fine solid particles and such that large and dense particles remain in the agglomeration classifier.

15. The method according to claim 14, wherein the water up flow velocity in the agglomeration classifier is as high as 25 cm/s or more to separate coarse solids such as gravel from water, from 1.0 cm/s to 25 cm/s to separate fine sand from water, and less than 1.0 cm/s to separate fine silt and clay from water.

16. The method according to claim 15, wherein the at least one agglomeration classifier tank has a constant horizontal cross sectional area with a tank height such that particles are retained in the hydraulic classifier according to particle size and up flow velocity.

17. The method according to claim 15, wherein the at least one agglomeration classifier tank has a variable horizontal cross sectional area with tank height such as a conical bottom tank, so particles are retained in the agglomeration classifier according to their particle size and up flow velocity at that position in the tank.

18. The method according to claim 15, wherein two or more agglomeration classifier tanks of increasing horizontal cross sectional areas are connected in series such that for a given volumetric flow rate, only large particles are retained in the small cross sectional area of the agglomeration classifier with a high up flow velocity, and small particles are retained in the large cross sectional area agglomeration classifier with a low up flow velocity.

19. The method according to claim 15, wherein agglomeration classified particles flow as a side-stream from the agglomeration classifier to a solids dewatering device such as a plate and frame filter press or centrifuge.

20. The method according to claim 1, further comprising the step of adding at least one oxygen donor to the process stream, the oxygen donor selected from the group consisting of ozone, hydrogen peroxide, sodium hypochlorite and mixtures thereof, the oxygen donor added in an amount sufficient to minimize odors such as arise from hydrogen sulphide, to arrest growth of microorganisms that form slime, and/or to form iron precipitates that may be separated from water.

21. A device for treating a solids-containing water, the device comprising:
at least on screen filter having an inlet;
at least one water conduit connected to the screen filter at a location downstream of the screen filter inlet,
at least one solids transfer conduit connected to the screen filter at a location downstream of the screen filter inlet at least one solids dewatering mechanism connected to the solids transfer conduit; and
at least one agglomeration classifier connected to the water conduit.

22. The device of claim 21 wherein the agglomeration classifier is a tank with liquid flow starting at or near the bottom of the tank and exiting at or near the top of the tank such that upwards fluid velocity suspends solid particles, where a high up flow velocity washes out fine solids and results in only large and dense particles remaining in the agglomeration classifier, and where a small up flow velocity retains both large and small particles in the agglomeration classifier.
